(19) United States
(12) Patent Application Publication
(10) Pub. No.: US 2023/0089925 A1
(43) Pub. Date: Mar. 23, 2023

(54) ASSIGNING JOBS TO HETEROGENEOUS GRAPHICS PROCESSING UNITS

(71) Applicant: Hewlett Packard Enterprise Development LP, Houston, TX (US)

(72) Inventors: Junguk Cho, Milpitas, CA (US); Puneet Sharma, Palo Alto, CA (US); Diman Zad Tootaghaj, Milpitas, CA (US)

(21) Appl. No.: 17/448,299

(22) Filed: Sep. 21, 2021

(51) Int. Cl. G06F 9/50; G06F 9/48; G06F 9/455

(52) U.S. Cl. CPC G06F 9/5077; G06F 9/4881; G06F 9/45558; G06F 2009/45595

(57) ABSTRACT

Architectures and techniques for managing heterogeneous sets of physical GPUs. Functionality information is collected for one or more physical GPUs with a GPU device manager coupled with a heterogeneous set of physical GPUs. At least one of the physical GPUs is to be managed as multiple virtual GPUs based on the collected functionality information with the GPU device manager. Each of the physical GPUs is classified as either a single physical GPU or as one or more virtual GPUs with the device manager. Traffic representing processing jobs to be processed is received by at least a subset of the physical GPUs via a gateway programmed by a traffic manager. The GPU application to process received processing jobs scheduled by and distributed into the scheduled GPU application with a GPU scheduler communicatively coupled with the traffic manager and with the GPU device manager.

### BACKGROUND

Graphics processing units (GPUs) were originally designed to accelerate graphics rendering, for example, for three-dimensional graphics. The GPU rendering functionality is provided as a parallel processing configuration. Over time, GPUs have become increasingly utilized for non-graphics processing. For example, artificial intelligence (AI), deep learning and high-performance computing (HPC), have increasingly utilized GPUs.

### BRIEF DESCRIPTION OF THE DRAWINGS

Examples described here are illustrated by way of example, and not by way of limitation, in the figures of the accompanying drawings in which like reference numerals refer to similar elements.

FIG. 1 is a block diagram of an example heterogeneous GPU cluster management system.

FIG. 2 is a conceptual diagram of a single GPU expressed as multiple virtual GPUs.

FIG. 3 is a block diagram of an example architecture having a GPU scheduler and GPU device manager for managing and scheduling virtual GPUs.

FIG. 4 is a block diagram of an example architecture having a GPU scheduler and GPU device manager for managing and scheduling virtual GPUs.

FIG. 5 is a conceptual illustration of workload distribution controlled by a gateway and traffic manager

FIG. 6 is an example flow diagram of a technique for managing heterogeneous GPUs.

FIG. 7 is a block diagram of one example implementation of a processing system for managing heterogeneous GPUs.

### DETAILED DESCRIPTION

Implementations described herein are directed to management of GPU resources. One example use for GPUs is to support deep neural network (DNN) functionality. That is, GPUs can be utilized to function as DNN accelerators. In the description that follows, many example implementations will be based around DNN accelerator applications, although the applicable implementations are not limited to DNN environments and may be useful in other artificial intelligence, machine learning, or deep learning environments or the like. More specifically DNN-based applications provide, for example, video analysis, object detection and voice recognition functionality. In many implementations, DNN functionality can be provided by multiple containerized applications.

The examples that follow provide the ability to manage groups of heterogeneous GPUs. In general, a group of heterogeneous GPUs includes different types of GPUs (e.g., GPUs with differences in features, performance and/or other characteristics including support, or lack of support, for various multiplexing techniques including spatial sharing). Any combination of different types of GPUs can be considered a group of heterogeneous GPUs. One example group of heterogeneous GPUs can include two physical GPUs that do not support spatial sharing and one physical GPU that supports spatial sharing and can be managed as multiple virtual GPUs.

Efficiently managing and utilizing heterogeneous GPUs can be complex. However, various example implementations that can function to efficiently share one or more GPUs amongst multiple containerized applications simultaneously as well as managing heterogeneous GPU hardware on a distributed cluster of servers are described herein.

Disadvantageous container platform implementations do not allow a fraction of a GPU to be allocated to a container or permit sharing of GPUs between containers while maintaining performance and data isolation. By contrast, in the description that follows, various implementations of heterogeneous-aware GPU cluster management systems that can function within container platforms are provided. In some implementations, a GPU resource abstraction is provided that functions to express one physical GPU as multiple logical (or virtual) GPUs. This enables the management of logical (virtual) GPUs as first-class computing resources within the container platform. In general, a first-class computing resource is a resource that has an identity independent of any other computing resource. This identity allows the item to persist when its attributes change and allows other resources to claim relationships with the first-class computing resource.

In some implementations, a GPU scheduler and GPU device manager can function to automate management of heterogeneous GPU hardware deployments. This supports efficient sharing of GPUs among multiple containerized applications by leveraging GPU sharing support within the container platform. In some implementations, the described architecture and mechanisms can support proportional distribution of requests (e.g., DNN inference requests) from multiple applications across available GPU hardware based on, for example, request information and computation capability of the various available GPUs.

In the example DNN-based implementations, GPUs can be utilized to perform, or support, analysis that involves voice recognition, machine learning, object detection and/or video analysis. This can be performed in a container-based operating environment (e.g., Kubernetes). Kubernetes (K8s) is an open-source container orchestration architecture for managing application deployment and management. Kubernetes can be utilized with container tools such as Docker (or other similar tools) to manage containers. Kubernetes is available from the Cloud Native Computing Foundation, and Docker is a virtualization and container tool available from Docker, Inc.

There are several advantages to running these types of applications in a container-based environment including, for example, self-monitoring, self-healing, scaling, automatic rollouts and rollbacks of applications. Because Kubernetes is designed for running containers on homogeneous CPU-centric resources, managing GPUs can be inefficient and/or difficult. Thus, while various types of GPUs and efficient spatial multiplexing of GPUs are possible, existing container platforms do not support this type of functionality. As a result, a model of exclusive GPU assignment to one container or pod (a pod being a group of containers), or a time multiplexing approach to GPU sharing are the more straight forward possible approaches. However, these approaches can result resource inefficiency and/or performance degradation.

In addition, because existing container platforms do not differentiate between GPU models having differing capacities and efficiencies, workload distribution (e.g., DNN inference requests) are uniformly distributed regardless of the capacity of the GPU, which can result in lower overall workload performance. Because GPU resources are limited and tend to be more expensive than CPU resources, the improved efficiency described herein to manage heterogeneous GPU resources that treats the GPUs as first-class computing resources can provide a much more efficient environment.

The various example implementations described herein can provide an environment that: 1) is automated and implements fine-grained GPU cluster management on a container platform; 2) enables efficient sharing of GPU resources among multiple containerized applications to increase resource efficiency with minimal overhead; and 3) leverages underlying GPU hardware heterogeneity to optimize workload distribution.

More specifically, example implementations can provide a heterogeneous-aware GPU cluster management system for use on a container platform. In various implementations, a new GPU resource abstraction is provided to express one physical GPU as multiple logical (virtual) GPUs. This enables the management of logical GPUs as first-class computing resources on a container platform. Further, it efficiently manages heterogeneous GPU resources according to GPU computation capability. These implementations can enable efficient sharing of GPU resources among multiple applications to increase resource efficiency with minimal overhead by leveraging spatial GPU sharing on a container platform and utilizing, for example, a bin-packing scheduling strategy. These implementations can further leverage underlying GPU hardware heterogeneity and application characteristics to optimize workload distribution. This enables the proportional distribution of requests (e.g., inference requests, workload) to multiple applications running on heterogeneous GPUs based on request information (e.g., batch size for inference requests or a neural network model) and the computation capability of the different GPUs.

In the examples that follow, one or more GPU applications running on container platforms are managed by various implementations of traffic managers, GPU managers and GPU schedulers to improve GPU utilization. The GPU device manager and GPU scheduler allocate one or more GPUs for the GPU applications and the traffic manager controls the distribution of requests to the GPU applications. As discussed in greater detail below, the GPUs can be a physical GPU, a logical GPU or some combination thereof.

The number of virtual GPUs allocated to an application can be based various characteristics of the application and/or requests from the application. In some implementations, the allocation can be dynamically modifiable as characteristics of the applications and/or requests change.

In the implementations described herein, each application can have separate and isolated paths through the entire memory system (e.g., on-chip crossbar ports, second level (L2) cache banks, memory controllers, dynamic random access memory (DRAM) addresses busses). Without this isolation one application could interfere with other applications if it had high demands, for example, for DRAM bandwidth or oversubscribed requests to the L2 cache.

This spatial multiplexing approach can provide better performance than a time multiplexing approach because it can allow the kernel execution of multiple applications to be overlapped. Also, spatial multiplexing allows good performance isolation among multiple applications sharing a single physical GPU. Further, spatial sharing can guarantee stable performance isolation with minimal overhead.

In some implementations, a container platform can treat different (i.e., heterogeneous) GPU models differently when performing application assignment to a GPU based on differences in GPU hardware performance capabilities. In some implementations, GPU resources are aligned with application requirements (e.g., low latency, high throughput). In some implementations, the container platform can leverage the performance of specific GPU hardware models when deploying application workloads. In some implementations, multiple applications can be assigned to a single GPU.

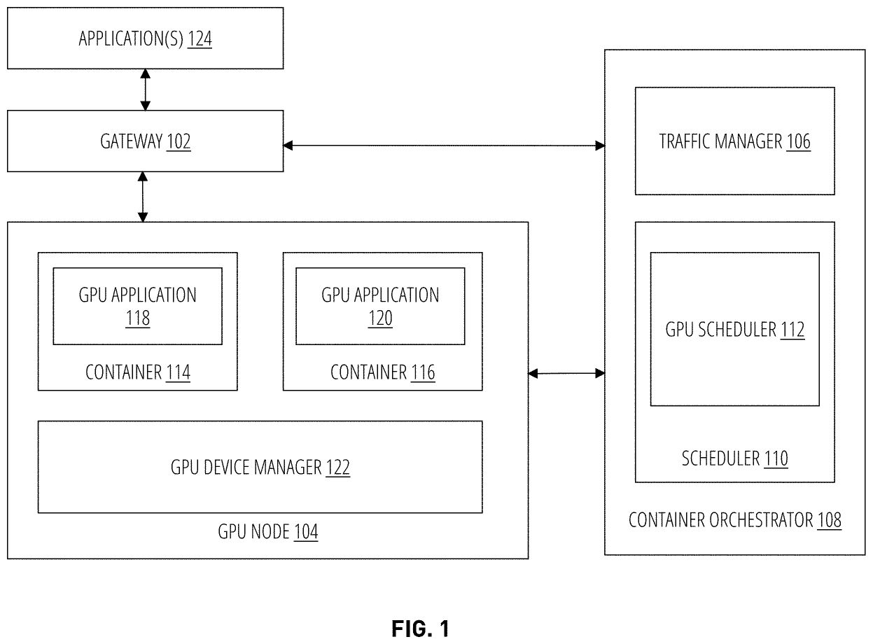

FIG. 1 is a block diagram of one implementation of a heterogeneous-aware GPU cluster management system. The system described can be used for many different types of processing, as one example, DNN inference applications. The architecture described provides a GPU resource abstraction by supporting the splitting of one physical GPU into multiple logical GPUs and managing the logical GPUs with a GPU scheduler and device manager to more efficiently manage GPU resources.

In one implementation, application(s) 124 send requests (e.g., inference requests) to, and receives responses from, gateway 102. Gateway 102 functions to send request information to, and receive response information from, GPU applications on GPU node 104. GPU node 104 is a hardware-based computing system with one or more physical GPUs as well as other hardware (e.g., processor, memory). GPU node 104 can be, for example, a server computer, a server blade, a desktop computer, a mobile computing device.

Gateway 102 is managed by traffic manager 106 to control traffic distribution. In one implementation, traffic manager 106 is part of container orchestrator 108 along with scheduler 110. In various implementations, scheduler 110 can further include GPU scheduler 112. A group of GPU nodes 104 can be grouped together to form a GPU cluster (not illustrated in FIG. 1).

GPU node 104 can include any number of containers (e.g., container 114, container 116) for corresponding GPU applications (e.g., GPU application 118, GPU application 120), that is, applications that utilize GPU resources at least in part to carry out computations. The placement of these GPU application containers on nodes of GPU node 104 by GPU scheduler 112 will be described below. In one implementation, GPU device manager 122 is deployed in each GPU node and is responsible for reporting GPU hardware specifications (e.g., GPU models, GPU memory, computation capability) to GPU scheduler 112 and for checking GPU health. For example, GPU node 104 may be part of a cluster of nodes (e.g., computers, servers, or virtual machines executing on hardware processing resources), and a container orchestrator, such as Kubernetes, may orchestrate the containers (e.g., container 114, container 116) running on the nodes of a cluster.

Application(s) 124 can function to request that some calculation be performed by a GPU, for example, any number of DNN inference requests. Application(s) 124 can submit these requests to/through gateway 102 and ultimately to GPU applications running on GPU node 104 where the requests can be assigned to a physical GPU and/or to one or more virtual GPUs as described in greater detail below.

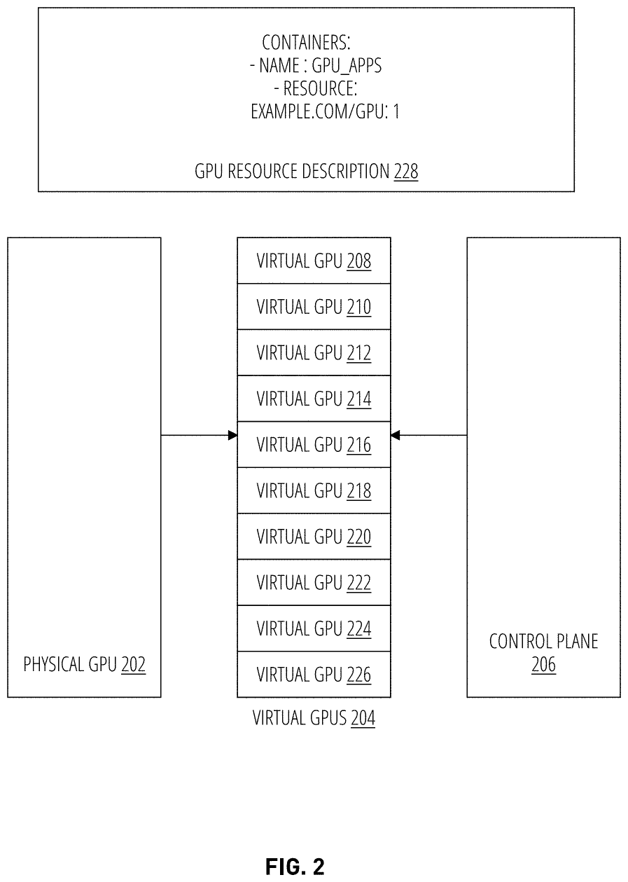

In one implementation, if a physical GPU supports spatial sharing, GPU device manager 122 can report multiple logical GPUs to GPU scheduler 112. For example, a single physical GPU can be reported to GPU scheduler 112 as ten logical GPUs. The number of logical GPUs can be configurable. For example, in an implementation, a user can specify GPU resources in a job description (e.g., specified in a manner similar to other resources such as CPU, memory). Example reporting of a single physical GPU as multiple virtual GPUs is illustrated in, and described in greater detail with respect to, FIG. 2.

In one implementation, GPU scheduler 112 gets detailed GPU information from GPU device manager 122 when new GPU clusters (or nodes) are added or removed and maintains the heterogeneous GPUs. As discussed above, heterogeneous GPUs have different sets of features (e.g., support for, or lack of support for, spatial sharing functionality). In one implementation, GPU scheduler 112 manages placement of GPU applications (e.g., GPU application 118, GPU application 120) on GPU node 104 based on various factors related to characteristics of the applications including, for example, the number of logical GPUs in the job description. In one implementation, GPU scheduler 112 continuously tracks available GPU resources (e.g., thread percentage on GPU, GPU memory, etc.) while assigning and releasing GPU resources to and from various applications.

In one implementation, GPU scheduler 112 utilizes a bin-packing scheduling strategy for sharing a GPU with multiple applications. Bin-packing strategies can be utilized to provide allocation of GPU resources to service application job requests. In general, bin-packing strategies can be utilized to support job requests having different weights (i.e., resource requirements) with a set of bins (i.e., that represent virtual GPUs) having known capacities. The bin-packing strategies can be utilized to support the job requests with the minimum number of virtual GPUs to provide efficient resource utilization. Thus, with bin-packing scheduling, GPU resources can be reserved for applications requiring greater GPU resources by avoiding GPU resource fragmentation.

In one implementation, for workload management in a GPU cluster, traffic manager 106 is responsible for managing request workload distribution by controlling gateway 102. In one example, GPU scheduler 112 functions to coordinate application containers (e.g., container 114, container 116) with GPU resources (i.e., a physical GPU and/or one or more virtual GPUs). As described in greater detail below, GPU capacity corresponds to ability to support application container requirements. Thus, GPU scheduler 112 functions to ensure that application container requirements are matched to GPU capacity through selecting one or more physical GPUs and/or virtual GPUs by matching known/detected GPU capacity information with application requirements.

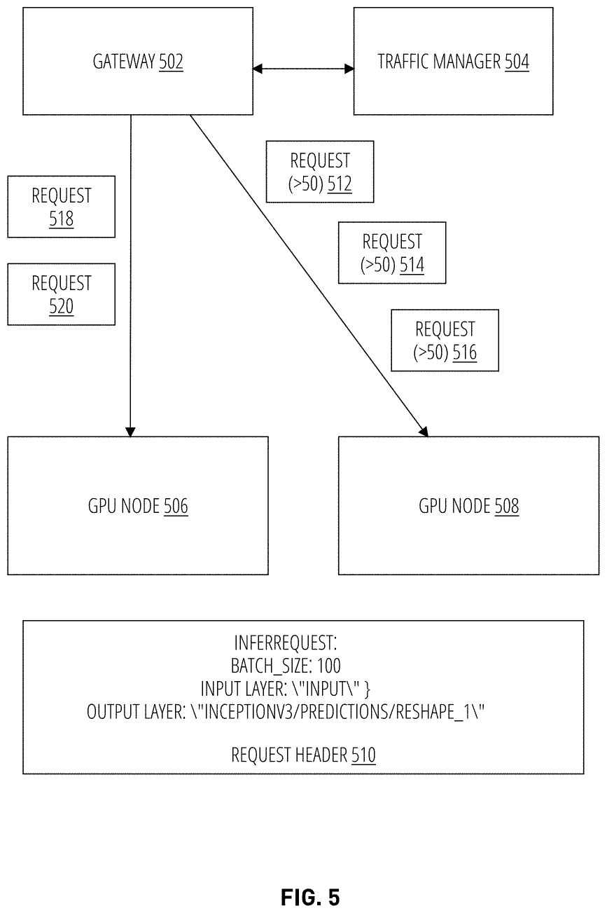

In the example of FIG. 1, traffic manager 106 routes incoming requests to appropriate GPUs to balance the current workload. Strategies for routing of application processing jobs are described in greater detail with respect to FIG. 5. Thus, the architecture of FIG. 1 can balance a dynamically changing workload in proportion to the allocated capacities to each application on each GPU.

In various implementations, traffic manager 106 can support one or more workload routing policies including, for example, hardware-aware routing policies and/or inference request-aware routing policies. Additional and/or different routing policies can also be supported.

Returning to the DNN inference example, use of hardware-aware routing policies can allow traffic manager 106 to adjust workload distribution by updating traffic rules in gateway 102 when inference requests are homogenous in one or more characteristics (e.g., batch size is uniform). In this manner, relatively more homogeneous request may be forwarded to GPU applications running on more powerful GPU nodes in a cluster (e.g., twice as many requests may be sent to a GPU more that is twice as powerful as a less powerful GPU node).

When the requests are heterogeneous (i.e., requests have different batch sizes), the heterogeneous requests can be distributed to different GPUs based on, for example, GPU computation capabilities. Traffic manager 106 can update gateway 102 to apply request-aware routing policies that determine the destination of requests based on a specific field (e.g., batch size) in the request. In other example implementations, other request characteristics can be utilized to estimate batch size, such as a “content-length” field in a HTTP or gRPC header of an inference request. In some implementations, batch size is indicated in an application-specific request header field (e.g., “batch_size” field), and this information can be provided in the application description.

Various example implementations may include various components (e.g., GPU device manager 122, GPU scheduler 112, traffic manager 106) and configurations. These component may provide the described functionality by hardware components or may be embodied in a combination of hardware (e.g., a processor) and a computer program or machine-executable instructions. Examples of a processor may include a microcontroller, a microprocessor, a central processing unit (CPU), a GPU, a data processing unit (DPU), an application specific integrated circuit (ASIC), a field programmable gate array (FPGA), a system-on-a-chip (SoC), etc. The computer program or machine-executable instructions may be stored on a tangible machine-readable medium such as random access memory (RAM), read-only memory (ROM), electrically erasable programmable read-only memory (EEPROM), flash memory, a hard disk drive, etc.

FIG. 2 is a conceptual diagram of a single GPU expressed as multiple virtual GPUs. In the example of FIG. 2 physical GPU 202 can be expressed as multiple (e.g., ten, twelve, twenty-four, fifty, etc.) virtual GPUs 204. Control plane 206 can manage and schedule virtual GPUs 204. Control plane 206 can include, in the example of FIG. 1, traffic manager 106, GPU scheduler 112 and/or GPU device manager 122. In one example, physical GPU 202 supports spatial multiplexing functionality.

The specific example of FIG. 2 illustrates a single physical GPU 202 expressed as ten virtual GPUs (virtual GPU 208, virtual GPU 210, virtual GPU 212, virtual GPU 214, virtual GPU 216, virtual GPU 218, virtual GPU 220, virtual GPU 222, virtual GPU 224, virtual GPU 226), collectively labeled virtual GPUs 204. In the example of FIG. 2, control plane 206 provides the control functionality described, for example, with respect to FIG. 1 for virtual GPUs 204.

In the example implementations, GPUs can be treated as first-class computing resources. For example, in a Kubernetes implementation, multiple virtual GPUs can be expressed as Extended Resources and virtual GPUs 204 can be reported with a resource name and quantity of the resource (e.g., example.com/gpus, 10). As discussed above, a user can specify a number of GPUs to be utilized in a job description (e.g., GPU resource description 228). Kubernetes control plane can assign virtual GPUs 204 as assignable resources for pods, in a like manner to assigning other computing resources such as CPU and memory. Other, non-Kubernetes configurations can manage GPU virtualization in a similar manner.

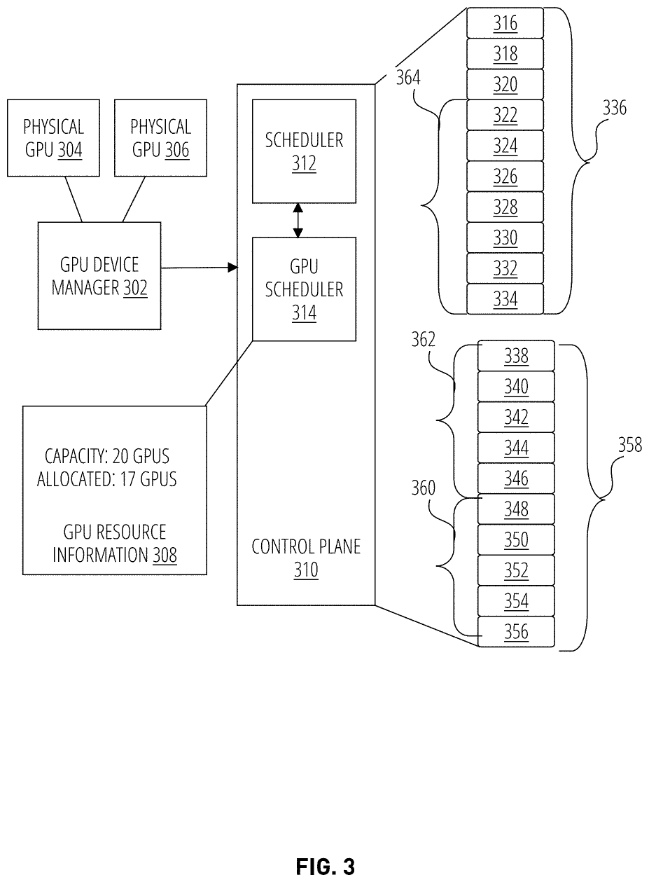

FIG. 3 is a block diagram of an example architecture having a GPU scheduler and GPU device manager for managing and scheduling virtual GPUs. In the example of FIG. 3, GPU device manager 302 can be coupled with one or more physical GPUs (e.g., physical GPU 304, physical GPU 306). GPU resource information 308 is provided by GPU device manager 302 to control plane 310 to be utilized by scheduler 312 and GPU scheduler 314 to provide GPU management and scheduling functionality. GPU scheduler 314 and GPU device manager 302 may be analogous to GPU scheduler 112 and GPU device manager 122, respectively, discussed above.

In the example of FIG. 3, each of physical GPU 304 and physical GPU 306 can be expressed as 10 virtual GPUs, although it should be understood that different examples may divide physical GPUs into different numbers of virtual GPUs. Thus, physical GPU 304 can be expressed as virtual GPU 316, virtual GPU 318, virtual GPU 320, virtual GPU 322, virtual GPU 324, virtual GPU 326, virtual GPU 328, virtual GPU 330, virtual GPU 332 and virtual GPU 334 (collectively labeled as virtual GPUs 336). Similarly, physical GPU 306 can be expressed as virtual GPU 338, virtual GPU 340, virtual GPU 342, virtual GPU 344, virtual GPU 346, virtual GPU 348, virtual GPU 350, virtual GPU 352, virtual GPU 354 and virtual GPU 356 (collectively labeled as virtual GPUs 358).

In one example, GPU scheduler 314 determines whether a physical GPU can provide enough GPU resources (i.e., prevent oversubscription conditions) to satisfy processing jobs received from one or more applications (not illustrated in FIG. 3). In one example, GPU scheduler 314 can utilize a bin-packing strategy to avoid GPU resource fragmentation. As one example, processing jobs from a first application can be assigned to a first group of virtual GPUs 360 that includes virtual GPU 348, virtual GPU 350, virtual GPU 352, virtual GPU 354 and virtual GPU 356. Similarly, processing jobs from a second application can be assigned to a second group of virtual GPUs 362 that includes virtual GPU 338, virtual GPU 340, virtual GPU 342, virtual GPU 344 and virtual GPU 346. Thus, processing jobs from two applications can be supported by the virtual GPUs of physical GPU 306.

Processing jobs from a third application can be assigned to a third group of virtual GPUs 364 that includes virtual GPU 322, virtual GPU 324, virtual GPU 326, virtual GPU 328, virtual GPU 330, virtual GPU 332 and virtual GPU 334. Thus, processing jobs from one application can be supported by the virtual GPUs of physical GPU 304 with capacity from the three remaining virtual GPUs (virtual GPU 316, virtual GPU 318 and virtual GPU 320) remaining available for additional applications or for increased needs of the applications currently supported.

In one example, GPU scheduler 314 is called from scheduler 312 (which can be, for example, a Kubernetes-based scheduler, analogous to scheduler 110, for example) to provide fine-grained scheduling functionality to augment the coarse-grained scheduling functionality provided by scheduler 312. GPU scheduler 314 can use, for example, GPU resource information 308 to determine the number of virtual GPUs available. Additional GPU resource information not illustrated in FIG. 3 can be utilized, for example, GPU-specific information in environments supporting multiple heterogenous GPUs. The resulting management and scheduling operation provided by architectures like the example of FIG. 3 can result in an improved overall throughput as compared to other management and scheduling strategies.

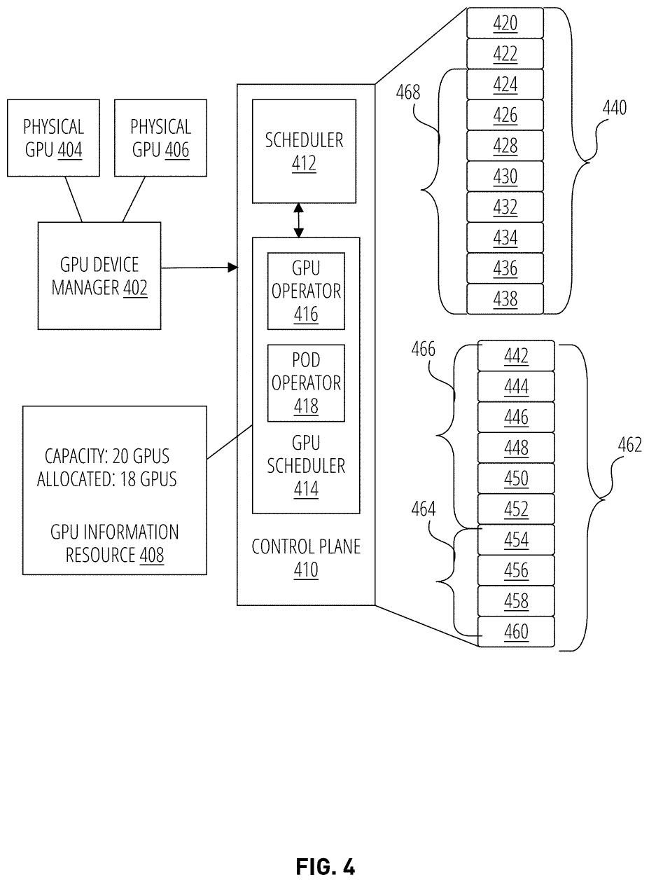

FIG. 4 is a block diagram of an example architecture having a GPU scheduler and GPU device manager for managing and scheduling virtual GPUs. In the example of FIG. 4, GPU device manager 402 can be coupled with one or more physical GPUs (e.g., physical GPU 404, physical GPU 406). GPU scheduler 414 maintains GPU information resource 408 as it scheduled GPU applications and provides detailed scheduled information to GPU device manager 402 to map the GPU assignment into a GPU application. GPU device manager 402 uses the mapping information when the GPU application is started. GPU scheduler 414 may be analogous to GPU scheduler 112 discussed above and functions in a similar manner to GPU scheduler 314 discussed above with the additional functionality of GPU operator 416 and Pod operator 418.

In the example of FIG. 4, each of physical GPU 404 and physical GPU 406 can be expressed as 10 virtual GPUs, although it should be understood that different examples may divide physical GPUs into different numbers of virtual GPUs. Thus, physical GPU 404 can be expressed as virtual GPU 420, virtual GPU 422, virtual GPU 424, virtual GPU 426, virtual GPU 428, virtual GPU 430, virtual GPU 432, virtual GPU 434, virtual GPU 436 and virtual GPU 438 (collectively labeled as virtual GPUs 440). Similarly, physical GPU 406 can be expressed as virtual GPU 442, virtual GPU 444, virtual GPU 446, virtual GPU 448, virtual GPU 450, virtual GPU 452, virtual GPU 454, virtual GPU 456, virtual GPU 458 and virtual GPU 460 (collectively labeled as virtual GPUs 462).

In one example, GPU scheduler 414 determines whether a physical GPU can provide enough GPU resources to satisfy processing jobs received from one or more applications (not illustrated in FIG. 4). In one example, GPU scheduler 414 can utilize a bin-packing strategy as described above. As one example, processing jobs from a first application can be assigned to a first group of virtual GPUs 464 that includes virtual GPU 454, virtual GPU 456, virtual GPU 458 and virtual GPU 460. Similarly, processing jobs from a second application can be assigned to a second group of virtual GPUs 466 that includes virtual GPU 442, virtual GPU 444, virtual GPU 446, virtual GPU 448, virtual GPU 450 and virtual GPU 452. Thus, processing jobs from two applications can be supported by the virtual GPUs of physical GPU 406.

Processing jobs from a third application can be assigned to a third group of virtual GPUs 468 that includes virtual GPU 424, virtual GPU 426, virtual GPU 428, virtual GPU 430, virtual GPU 432, virtual GPU 434, virtual GPU 436 and virtual GPU 438. Thus, processing jobs from one application can be supported by the virtual GPUs of physical GPU 404 with capacity from the two remaining virtual GPUs (virtual GPU 420 and virtual GPU 422) remaining available for additional applications or for increased needs of the applications currently supported.

In a Kubernetes-based architecture example, GPU device manager 402 can provide information to identify GPU type and specifications such as nodeName, GPUIndex, UUID, Model, Major, Minor, ComputeCapability. Other and/or different GPU information can also be utilized. GPU operator 416is used to monitor the reported information from GPU device manager 402. Pod operator 418 is used to monitor pod creation, update and deletion events. GPU scheduler 414 schedules submitted jobs based on this information. As a further example, GPU device manager 402 can further provide allocation status information to pod operator 418 and GPU scheduler 414 can track GPU assignment to container pods. Other, non-Kubernetes, configurations can provide similar functionality using alternative structures and specifications.

FIG. 5 is a conceptual illustration of an example workload distribution controlled by a gateway 502 and traffic manager 504, which may be examples of gateway 102 and traffic manager 106. In an example, gateway 502 can receive requests from one or more applications (applications not illustrated in FIG. 5) and can interoperate with traffic manager 504 to route requests to specified GPU nodes, such as GPU node 506 and GPU node 508. In one example, traffic manager 504 functions to generate matching rules and program the rules to control gateways 502 to route requests to GPU node 506 or GPU node 508 based on matching results against request header 510. GPU node 506 and GPU node 508 can be analogous to GPU node 104 in FIG. 1.

Any number of workload routing policies can be supported with the configuration of FIG. 5. The specific example of FIG. 5 provides two workload routing policies: a hardware-aware workload routing policy and a request-aware workload routing policy. In some example implementations, the configuration of FIG. 5 can leverage service mesh capabilities (e.g., Istio).

In the request-aware workload routing policy example of FIG. 5, if a batch size (e.g., as determined from request header 510) exceeds a specified threshold (e.g., 50, 100) corresponding requests can be routed to a higher performance GPU node (e.g., GPU node 508). In the example of FIG. 5, gateway 502 can receive and forward requests having batch sizes greater than the specified threshold. In the specific example of FIG. 5, the illustrated threshold is 50; however, any threshold can be supported. Thus, the requests (e.g., request (>50) 512, request (>50) 514, request (>50) 516) that exceed threshold can be routed to a GPU node 508) having sufficient resources to service the larger batches. Otherwise, requests with batch sizes that do not exceed the threshold (e.g., request 518, request 520) can be routed to a default GPU node (e.g., GPU node 506). In some implementations, additional and/or different workload routing policies can also be supported.

The example of FIG. 5 is based on a single routing criteria and illustrates only two GPU nodes; however, more complex routing criteria with multiple routes based on multiple characteristics (e.g., multiple bands of request size route to respective GPU nodes or classes or GPU node). Further, any number of GPU nodes can be supported with the various routing criteria.

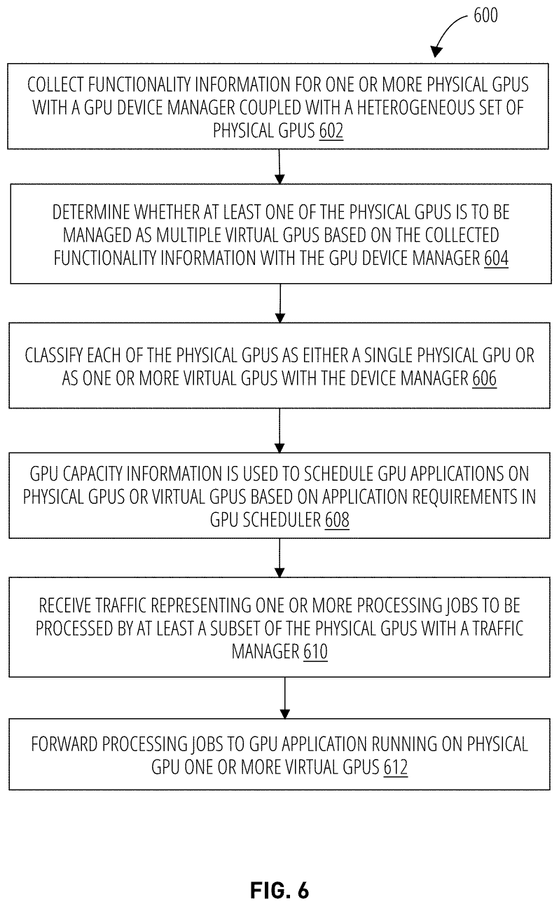

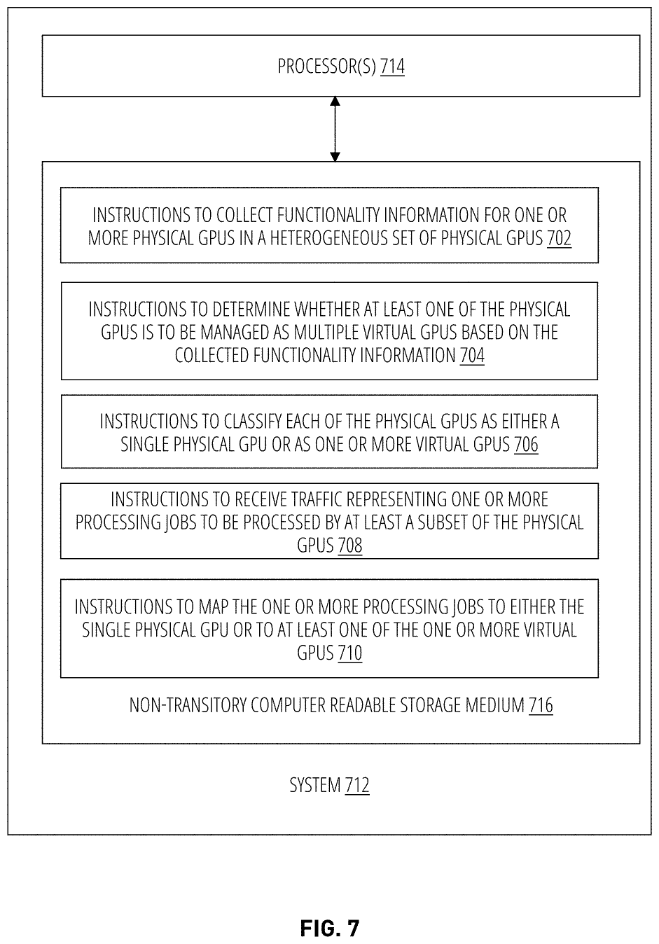

FIG. 6 is a flow diagram of one example technique for managing sets of heterogeneous GPUs. Technique 600 can be provided or performed, for example, by the components illustrated in, and described with respect to, FIG. 1, FIG. 2, FIG. 3, FIG. 4, FIG. 5 and FIG. 7.

In block 602, a GPU device manager (e.g., GPU device manager 302) collects functionality information for one or more physical GPUs (e.g., physical GPU 304, physical GPU 306). Any number and model of physical GPUs can be supported. In one example, a heterogeneous set of physical GPUs can include at least one physical GPU that is not to be represented as one or more virtual GPUs and at least one physical GPU that supports spatial sharing functionality. In other examples, all physical GPUs can be represented as multiple virtual GPUs.

In block 604, the GPU device manager determines whether at least one of the physical GPUs is to be managed as multiple virtual GPUs based on the collected functionality information. Physical GPUs that can be represented as one or more virtual GPUs can be presented to a GPU scheduler (e.g., GPU scheduler 314) and/or other components as a set one or more of the virtual GPUs, although it should be understood that different examples may divide physical GPUs into different numbers of virtual GPUs.

In block 606, the GPU device manager classifies each of the physical GPUs as either a single physical GPU or as one or more virtual GPUs based on, for example, reading GPU functionality information. For example, the GPU device manager can evaluate whether a physical GPU can be represented by virtual GPUs with its computation capacity. In a Kubernetes implementation, one or more of the virtual GPUs can be expressed as Extended Resources and can be reported with a resource name and quantity to, for example, GPU operator 416 in GPU scheduler 414. Kubernetes control plane (e.g., control plane 410) can assign virtual GPUs as assignable resources for pods, in a like manner to assigning other computing resources such as CPU and memory. Other, non-Kubernetes configurations can manage GPU virtualization in a similar manner.

In block 608, GPU functionality and GPU resource information (e.g., GPU information resource 408) are used to schedule GPU applications on physical GPUs one or more virtual GPUs based on the application requirements in the GPU scheduler (e.g., GPU scheduler 414). The GPU device manager (e.g., GPU device manager 402) maps the GPU applications to the physical GPU or two one or more virtual GPUs based on the scheduling information when a GPU application is started.

In block 610, a gateway programmed by the traffic manager (e.g., gateway 102 and traffic manager 106) can receive traffic representing one or more processing jobs to be processed by at least a subset of the physical GPU one or more virtual GPUs. The traffic can include requests, for example, DNN inference requests to be processed by one or more GPUs. The requests can have associated batch sizes and/or other relevant characteristics (e.g., indicated by request header 510). Other types of processing requests for GPU resources can also be supported in a similar manner.

In block 612, the one or more processing jobs is forwarded to the GPU application running on the physical GPU one or more virtual GPUs based on GPU application assignment results (i.e., job scheduling in the GPU scheduler).

FIG. 7 is a block diagram of one example implementation of a system. In an example, system 712 can include processor processor(s) 714 and non-transitory computer readable storage medium 716. Non-transitory computer readable storage medium 716 may store instructions 702, 704, 706, 708 and 710 that, when executed by processor(s) 714, cause processor(s) 714 to perform various functions. Examples of processor(s) may include a microcontroller, a microprocessor, a CPU, a GPU, a DPU, an ASIC, a FPGA, an SoC, etc. Examples of a non-transitory computer-readable storage medium include tangible media such as RAM, ROM, EEPROM, flash memory, a hard disk drive, etc.

In an example, instructions 702 cause processor(s) 714 to collect functionality information for one or more physical GPUs in a set of physical GPUs. Any number of physical GPUs can be supported. In one example, a heterogeneous set of physical GPUs can include at least one physical GPU that is not to be represented as one or more virtual GPUs and at least one physical GPU that supports spatial sharing functionality. In other examples, all physical GPUs can be represented as multiple virtual GPUs.

In an example, instructions 704 cause processor(s) 714 to determine whether at least one of the physical GPUs is to be managed as multiple virtual GPUs based on the collected functionality information. In an example, instructions 706 cause processor(s) 714 to classify the physical GPUs each as either a single physical GPU or as one or more virtual GPUs.

In an example instructions 708 cause processor(s) 714 to receive traffic representing one or more processing jobs to be processed by at least a subset of the physical GPUs. As discussed above, the processing jobs can correspond to DNN inference requests, or to other types of processing jobs that can be serviced by the GPUs. In an example, instructions 710 cause processor(s) 714 to map the one or more processing jobs to either the single physical GPU or to at least one of the virtual GPUs. The mapping of the processing jobs can be accomplished, for example, as illustrated in, and described with respect to, FIG. 5.

In the description above, for the purposes of explanation, numerous specific details are set forth in order to provide a thorough understanding of the described implementations. It will be apparent, however, to one skilled in the art that implementations may be practiced without some of these specific details. In other instances, well-known structures and devices are shown in block diagram form. There may be intermediate structure between illustrated components. The components described or illustrated herein may have additional inputs or outputs that are not illustrated or described.

Various implementations may include various processes. These processes may be performed by hardware components or may be embodied in computer program or machine-executable instructions, which may be used to cause - processor or logic circuits programmed with the instructions to perform the processes. Alternatively, the processes may be performed by a combination of hardware and software.

Portions of various implementations may be provided as a computer program product, which may include a non-transitory computer-readable medium having stored thereon computer program instructions, which may be used to program a computer (or other electronic devices) for execution by one or more processors to perform a process according to certain implementations. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, implementations may also be downloaded as a computer program product, wherein the program may be transferred from a remote computer to a requesting computer. In some implementations, non-transitory computer readable storage medium 716 has stored thereon data representing sequences of instructions that, when executed by a processor, cause the processor to perform certain operations.

An implementation is an implementation or example. Reference in the specification to “an implementation,” “one implementation,” “some implementations,” or “other implementations” means that a particular feature, structure, or characteristic described in connection with the implementations is included in at least some implementations, but not necessarily all implementations. Additionally, such feature, structure, or characteristics described in connection with “an implementation,” “one implementation,” “some implementations,” or “other implementations” should not be construed to be limited or restricted to those implementation(s), but may be, for example, combined with other implementations. The various appearances of “an implementation,” “one implementation,” or “some implementations” are not necessarily all referring to the same implementations.

What is claimed is:

1. A system comprising:
a graphics processing unit (GPU) device manager to:
communicate with a heterogeneous set of one or more physical GPUs,
collect capacity information for the one or more physical GPUs,
determine whether any of the one or more physical GPUs is capable of supporting functioning as one or more virtual GPUs and,
for the physical GPUs capable of functioning as one or more virtual GPUs, provide an indication of availability of a set of virtual GPUs from among the one or more physical GPUs capable of functioning as one or more virtual GPUs;
a GPU scheduler communicatively coupled with the GPU device manager, the GPU scheduler to:
receive the capacity information for the one or more physical GPUs and the indication of availability of the set of virtual GPUs from the GPU device manager,
track available GPU resources corresponding to the one or more physical GPUs, and
assign GPU resources to processing jobs received from one or more applications.

2. The system of claim 1, wherein the one or more virtual GPUs correspond to at least one physical GPU having spatial sharing functionality.

3. The system of claim 1, wherein the GPU scheduler utilizes a bin-packing strategy to assign processing jobs either to a single physical GPU or to one or more virtual GPUs based on processing job characteristics.

4. The system of claim 3, wherein the processing jobs are received from applications operating in a container-based operating environment.

5. The system of claim 4, wherein at least one processing job comprises a deep neural network (DNN) requests.

6. The system of claim 1, the GPU device manager further to collect and report GPU hardware capacity information.

7. The system of claim 6, wherein the GPU hardware capacity information comprises GPU model information, GPU memory information and GPU computation capability information.

8. A method comprising:
collecting functionality information for one or more physical GPUs with a GPU device manager coupled with a heterogeneous set of physical GPUs;
determining whether at least one of the physical GPUs is to be managed as multiple virtual GPUs based on the collected functionality information with the GPU device manager;
classifying each of the physical GPUs as either a single physical GPU or as one or more virtual GPUs with the device manager;
receiving processing jobs from one or more GPU applications distributed by a gateway and managed by a traffic manager to be forwarded to one of the one or more GPU applications running on at least a subset of the one or more physical GPUs or one or more of the virtual GPUs; and
assigning the received processing jobs to either at least one of the one or more physical GPUs or to at least one of the one or more virtual GPUs with a GPU scheduler communicatively coupled with the traffic manager and with the GPU device manager, wherein the assigning of GPU application to processing job is based on available GPU resources and resource requirements of the GPU application.

9. The method of claim 8, wherein the set of virtual GPUs correspond to at least one physical GPU having spatial sharing functionality.

10. The method of claim 8, wherein the GPU scheduler utilizes a bin-packing strategy to assign processing jobs either to a single physical GPU or to one or more virtual GPUs based on processing job characteristics.

11. The method of claim 10, wherein the one or more processing jobs are received from applications operating in a container-based operating environment.

12. The method of claim 11, wherein at least one processing job comprises a deep neural network (DNN) processing job.

13. The method of claim 8, further comprising collecting and reporting GPU hardware capacity information with the GPU device manager.

14. The method of claim 13, wherein the GPU hardware capacity information comprises GPU model information, GPU memory information and GPU computation capability information.

15. A non-transitory computer-readable storage medium having instructions stored therein that, when executed by a computer, cause the computer to:
collect functionality information for one or more physical GPUs with a GPU device manager coupled with a heterogeneous set of physical GPUs;
determine whether at least one of the physical GPUs is to be managed as multiple virtual GPUs based on the collected functionality information with the GPU device manager;
classify each of the physical GPUs as either a single physical GPU or as one or more virtual GPUs with the device manager;
receive processing jobs from one or more GPU applications distributed by a gateway and managed by a traffic manager to be forwarded to one of the one or more GPU applications running on at least a subset of the one or more physical GPUs or one or more of the virtual GPUs; and
assign the received processing jobs to either at least one of the one or more physical GPUs or to at least one of the one or more virtual GPUs with a GPU scheduler communicatively coupled with the traffic manager and with the GPU device manager, wherein the assigning of GPU application to processing job is based on available GPU resources and resource requirements of the GPU application.

16. The non-transitory computer-readable storage medium of claim 15, wherein the set of virtual GPUs correspond to at least one physical GPU having spatial share functionality.

17. The non-transitory computer-readable storage medium of claim 15, wherein the GPU scheduler utilizes a bin-packing strategy to assign processing jobs either to a single physical GPU or to one or more virtual GPUs based on processing job characteristics.

18. The non-transitory computer-readable storage medium of claim 17, wherein the one or more processing jobs are received from applications operate in a container-based operating environment.

19. The non-transitory computer-readable storage medium of claim 18, wherein at least one processing job comprises a deep neural network (DNN) processing job.

20. The non-transitory computer-readable storage medium of claim 18, further comprising instructions that, when executed, cause the computer to collect and reporting GPU hardware capacity information with the GPU device manager.
